(19) United States
(12) Patent Application Publication
(10) Pub. No.: US 2016/0335031 A1
(43) Pub. Date: Nov. 17, 2016

(54) SYSTEMS AND METHODS FOR PRINTING DOCUMENTS IN MULTIPLE BACKGROUND COLORS

(71) Applicant: Xerox Corporation, Norwalk, CT (US)

(72) Inventor: ANNIE SHEEBA JOHN GONSALVES, NADU (IN)

(21) Appl. No.: 14/711,809

(22) Filed: May 14, 2015

(51) Int. Cl. G06F 3/12; G06K 15/02; G06K 15/00

(52) U.S. Cl. CPC G06F 3/1204; G06F 3/1258; G06F 3/1297; G06F 3/1256; G06K 15/005; G06K 15/188

(57) ABSTRACT

Systems and methods for printing documents in multiple background colors. A print job having a document is received into a computerized device. Background areas for the document are identified. Input is received to produce a first number of copies of the document with the background areas having a selected first color. Input is received to produce a second number of copies of the document with the background areas having a selected second color. A revised print job is created including the selected first number of copies of the document having the selected first color for the background areas and the selected second number of copies of the document having the selected second color for the background areas. The revised print job is transmitted from the computerized device to a marking device. The marking device prints the revised print job.

### BACKGROUND

Systems and methods herein generally relate to machines having print engines such as printers and/or copier devices and, more particularly, to methods of providing multiple user-specified background colors for printed output.

In modern desktop printing systems, a document can be created or received in electronic form on a device such as a personal computer, a personal digital assistant, or other suitable device. Alternatively, a document can be scanned into a device. Parameters of print jobs (such as for finishing, imposition, color management) are typically set in the print job using a job ticket. Thereafter, the document can be printed on a printer to produce a hardcopy of the document. The hardcopy of the document can further be bound or otherwise subjected to processing to result in a finished product.

If a user desires to scan or print a document, there is no option to change the color of the background of the scanned document. Further, there is no option to print the document with background changes in many colors at a time. That is, there is no option for choosing a selected number of printouts for each desired color.

### SUMMARY

In one aspect of a method disclosed herein, a user can scan or select a document and print a selected number of papers of the document in multiple colors at a time. A “Color Picker”, which includes a set of common colors, is introduced. A check box, or other appropriate selector, may be displayed on a user interface to allow the user to select the desired color for selected portions of the document. There may also be a text box, or other appropriate means, displayed on the user interface to allow the user to enter numeric values next to the selected colors. The text box allows the user to enter a value in the text field next to the respective color in order to print multiple pages in any of the selected colors. After the user has scanned or selected the document, the user presses the Start button, and the printer produces the papers in all the selected numbers and colors, continuously, without further user intervention.

According to a method herein, a print job is received into a computerized device. The print job comprises a document. Background areas for the document are identified based on the print job. Input is received to produce a first number of copies of the document with the background areas having a selected first color. Input is received to produce a second number of copies of the document with the background areas having a selected second color. A revised print job is created. The revised print job is transmitted from the computerized device to a marking device operatively connected to the computerized device. The marking device is caused to print the revised print job.

According to another method herein, a print job is received into a computerized device. The print job includes print job settings for printing a document. Input is received, into the computerized device, to produce a first number of copies of the document with a portion of the document having a selected first color. Input is received, into the computerized device, to produce a second number of copies of the document with the portion of the document having a selected second color. The first color is different from the second color. A revised print job is created, using the computerized device, to cause a marking device to automatically print the first number of the document having the portion of the document in the first color and to cause the marking device to automatically print the second number of the document having the portion of the document in the second color.

According to a device, a computerized device is connected to a marking device. The computerized device receives a print job comprising a document. A graphic user interface is operatively connected to the computerized device. The computerized device identifies background areas for the document, based on the print job. The graphic user interface receives input to produce a first number of copies of the document with the background areas having a selected first color. The graphic user interface receives input to produce a second number of copies of the document with the background areas having a selected second color. The computerized device creates a revised print job. The revised print job comprises the first number of copies of the document having the selected first color for the background areas and the second number of copies of the document having the selected second color for the background areas. The computerized device transmits the revised print job to the marking device. The computerized device causes the marking device to print the revised print job.

These and other features are described in, or are apparent from, the following detailed description.

### BRIEF DESCRIPTION OF THE DRAWINGS

Various examples of the systems and methods are described in detail below, with reference to the attached drawing figures, which are not necessarily drawn to scale and in which:

FIG. 1 is a side-view schematic diagram of a multi-function device according to systems and methods herein;

FIG. 2 is a flow diagram illustrating methods herein;

FIG. 3 is a block diagram of a user interface according to systems and methods herein;

FIG. 4 is a block diagram of a user interface according to systems and methods herein; and

FIG. 5 is a schematic diagram illustrating systems and methods herein.

### DETAILED DESCRIPTION

The disclosure will now be described by reference to a printing device that includes a color selection option. Multiple user-specified background colors for printed output can be selected at either the scan or print job submission level, on the fly. While the disclosure will be described hereinafter in connection with specific systems and methods thereof, it will be understood that limiting the disclosure to such specific systems and methods is not intended. On the contrary, it is intended to cover all alternatives, modifications, and equivalents as may be included within the spirit and scope of the disclosure as defined by the appended claims.

For a general understanding of the features of the disclosure, reference is made to the drawings. In the drawings, like reference numerals have been used throughout to identify identical elements.

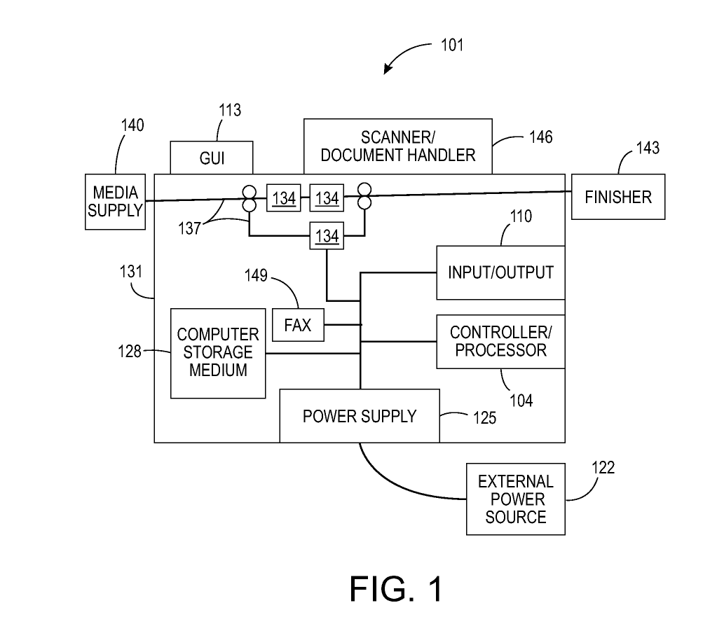

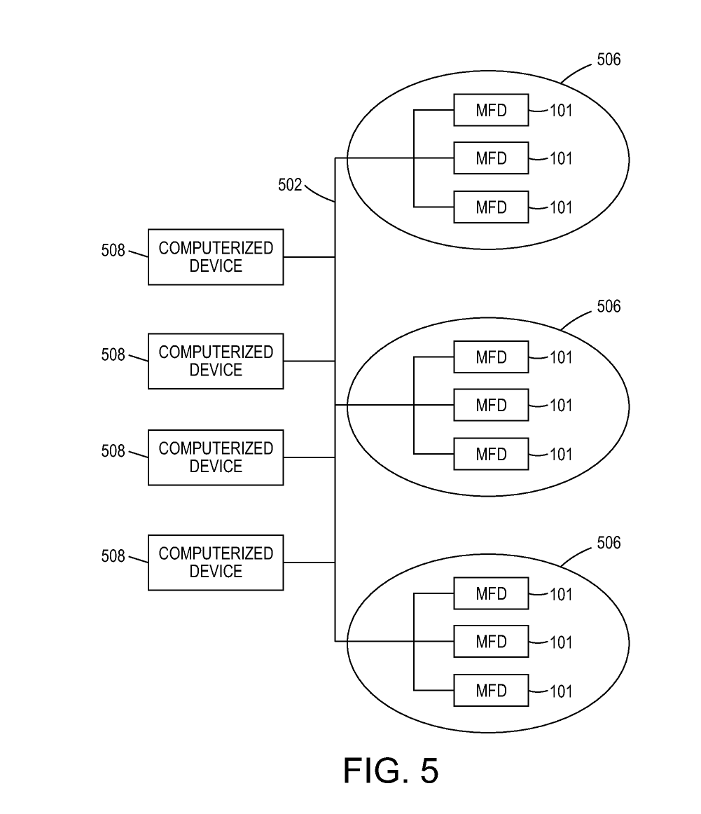

FIG. 1 illustrates a multi-function device 101 that can be used with systems and methods herein and can comprise, for example, a printer, a copier, a fax machine, etc. The multi-function device 101 includes a controller/processor 104 and an input/output device 110 operatively connected to the controller/processor 104. As described above, the controller/processor 104 may be connected and to a computerized network 502 external to the multi-function device 101 through a communications port of the input/output device 110, such as shown in FIG. 5, described below. In addition, the multi-function device 101 can include at least one accessory functional component, such as a graphic user interface assembly (GUI) 113. The GUI 113 operates on power supplied from an external power source 122. The external power source 122 may provide electrical power through the power supply 125.

The input/output device 110 is used for communications to and from the multi-function device 101. The controller/processor 104 controls the various actions of the multi-function device 101. A non-transitory computer storage medium 128 (which can be optical, magnetic, capacitor based, etc.) is readable by the controller/processor 104 and stores instructions that the controller/processor 104 executes to allow the multi-function device 101 to perform its various functions, such as those described herein.

According to systems and methods herein, the controller/processor 104 may comprise a special purpose processor that is specialized for processing image data and includes a dedicated processor that would not operate like a general purpose processor because the dedicated processor has application specific integrated circuits (ASICs) that are specialized for the handling of image processing operations, processing image data, determining color arrangement, etc. In one example, the multi-function device 101 is special purpose machine that includes a specialized image processing card having unique ASICs for providing image processing instructions, includes specialized boards having unique ASICs for input and output devices to speed network communications processing, a specialized ASIC processor that performs the logic of the methods described herein using dedicated unique hardware logic circuits, etc. It is contemplated that the controller/processor 104 may comprise a raster image processor (RIP). A raster image processer uses the original image description to RIP the print job. Accordingly, the print instruction data is converted to a printer-readable language. The print job description is generally used to generate a ready-to-print file. The ready-to-print file may be a compressed file that can be repeatedly accessed for multiple (and subsequent) passes.

It should be understood that the controller/processor 104 as used herein comprises a computerized device adapted to perform (i.e., programmed to perform, configured to perform, etc.) the below described system operations. According to systems and methods herein, the controller/processor 104 comprises a programmable, self-contained, dedicated mini-computer. The details of such computerized devices are not discussed herein for purposes of brevity and reader focus.

Thus, as shown in FIG. 1, a device housing 131 has one or more functional components that operate on power supplied from the external power source 122, which may comprise an alternating current (AC) power source, through the power supply 125. The power supply 125 can comprise a power storage element (e.g., a battery) and connects to the external power source 122. The power supply 125 converts the electrical power from the external power source 122 into the type of power needed by the various components of the multi-function device 101.

The multi-function device 101 may include at least one marking device 134 (sometimes referred to as printing engines) operatively connected to the controller/processor 104, a media path 137 positioned to supply sheets of media from a media supply 140 to the marking device(s) 134, etc., along the media path 137. After receiving various markings from the printing engine(s), the sheets of media can optionally pass to a finisher 143 which can fold, staple, sort, etc., the various printed sheets. In addition, the multi-function device 101 can include at least one accessory functional component (such as a scanner/document handler 146, fax module 149, etc.) that also operates on the power supplied from the external power source 122 (through the power supply 125). The fax module 149 may operate in conjunction with the scanner/document handler 146.

The scanner/document handler 146 may be any image input device capable of obtaining information from an image. The set of image input devices is intended to encompass a wide variety of devices such as, for example, digital document devices, computer systems, memory and storage devices, networked platforms such as servers and client devices which can obtain pixel values from a source device, and image capture devices. The set of image capture devices includes scanners, cameras, photography equipment, facsimile machines, photo reproduction equipment, digital printing presses, xerographic devices, and the like. A scanner is one image capture device that optically scans images, print media, and the like, and converts the scanned image into a digitized format. Common scanning devices include variations of the flatbed scanner, generally known in the art, wherein specialized image receptors move beneath a platen and scan the media placed on the platen. Modern digital scanners typically incorporate a charge-coupled device (CCD) or a contact image sensor (CIS) as the image sensing receptor(s). The scanning device produces a signal of the scanned image data. Such a digital signal contains information about pixels such as color value, intensity, and their location within the scanned image.

Further, an image output device is any device capable of rendering the image. The set of image output devices includes digital document reproduction equipment and other copier systems as are widely known in commerce, photographic production and reproduction equipment, monitors and other displays, computer workstations and servers, including a wide variety of color marking devices, and the like.

To render an image is to reduce the image data (or a signal thereof) to viewable form; store the image data to memory or a storage device for subsequent retrieval; or communicate the image data to another device. Such communication may take the form of transmitting a digital signal of the image data over a network.

As would be understood by those ordinarily skilled in the art, the multi-function device 101 shown in FIG. 1 is only one example and the systems and methods herein are equally applicable to other types of printing devices that may include fewer components or more components. For example, while a limited number of printing engines and paper paths are illustrated in FIG. 1, those ordinarily skilled in the art would understand that many more paper paths and additional printing engines could be included within any printing device used with systems and methods herein.

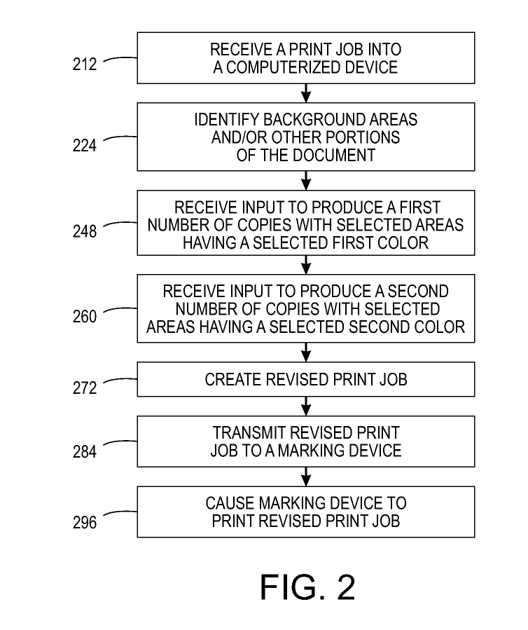

FIG. 2 is a flow diagram illustrating the processing flow of an exemplary method according to systems and methods herein. At 212, a print job is received into a computerized device. The print job includes a document, which may be obtained by scanning a page or may be created or received from a desktop printing system. At 224, background areas and/or other portions of the document are identified, based on the print job. At 248, input is received to produce a first number of copies of the document with the background areas having a selected first color. That is, the user can select the number and first color for at least a portion of the document. At 260, input is received to produce a second number of copies of the document with the background areas having a selected second color. The first color is different from the second color. At 272, a revised print job is created to cause a marking device to automatically print the first number of the document having the background of the document in the first color and to cause the marking device to automatically print the second number of the document having the background of the document in the second color. The revised print job comprises: the first number of copies of the document having the selected first color for the background areas and the second number of copies of the document having the selected second color for the background areas. At 284, the revised print job is transmitted from the computerized device to a marking device operatively connected to the computerized device. At 296, the marking device is caused to print the revised print job.

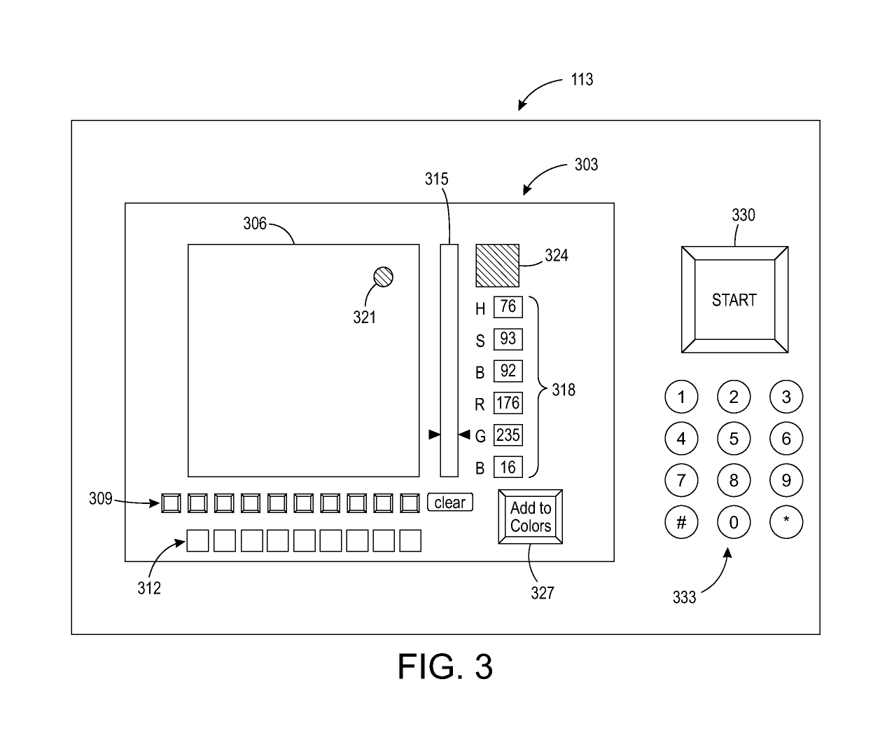

FIG. 3 shows an exemplary screen and control panel for a GUI 113 according to systems and methods herein. The screen, indicated generally as 303, includes a color window 306, color check boxes 309, or other appropriate selector devices, and text boxes 312, or other appropriate means. The screen 303 may also include an adjustable color spectrum 315 having various indications of color saturations levels, as shown at 318. The color window 306 may include a spot 321, or other indication of a particular color, which may be amplified in a corresponding display square 324. That is, the color in the spot 321 is the same as the color in the display square 324, and may be based on sliding the adjustable color spectrum 315. Each of the color check boxes 309 represents a color selectable for use in printing a document, as described below. In some cases, the color check boxes 309 may be initially prefilled with standard colors. The colors can be set as standard colors or a user can formulate a particular combination of colors, using the adjustable color spectrum 315, and add the resultant color to the color check boxes 309 by using an “Add to Colors” button 327, or other appropriate device. As is known by one of ordinary skill in the relevant art, by using the combination of cyan, magenta, yellow and black (CMYK), multiple colors can be made. The GUI 113 may also include a control panel including a START button 330 and a numeric keypad 333. The numeric keypad 333 allows the user to enter a value in the text boxes 312 associated with the respective color in order to print multiple jobs in any of the selected colors with a single press of the START button 330. In some cases, the text boxes 312 may be initially prefilled with a default number, such as ‘1’.

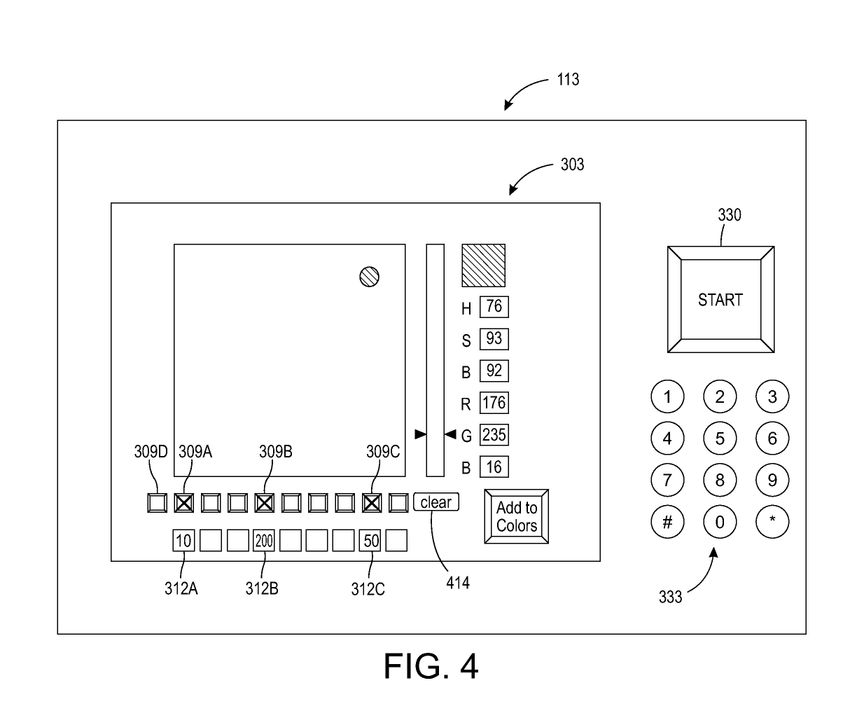

FIG. 4 illustrates an example in which a user wants to print certain numbers of a document with selected colors. The following steps may be used:

1. The user places a document on the scanner/document handler 146 of a multifunction device 101 and selects to copy or scan the document.

2. A preview of the document may be displayed on the screen 303 of the GUI 113.

3. In the example shown in FIG. 4, the user wants to print 260 documents in multiple colors.

4. A “Color Picker” option, such as shown in FIG. 4, is displayed on the screen 303. The “Color Picker” has set of common colors for color check boxes 309 displayed in the screen 303. The user can select the color as desired. For example, the user may select colors represented under check box 309a, 309b, and 309c. (Note: the user can select all the colors by using the common check box 309d or remove all the color selections by using a clear button 414, or other appropriate device.)

5. The numeric keypad 333 allows the user to enter a value in the text boxes 312 associated with the respective colors. For example, the user may select 10 copies (indicated at 312a) for the color represented under check box 309a, 200 copies (indicated at 312b) for the color represented under check box 309b, and 50 copies (indicated at 312c) for the color represented under check box 309c.

6. When the user clicks on the START button 330, the printer will print 10 papers in the first color represented under check box 309a, 200 papers in the second color represented under check box 309b, and 50 papers in the third color represented under check box 309c.

As described in the illustrated example, for one click on the START button 330, 260 copies of the document are printed in the selected colors. There is no need to press the START button 330 for every color.

As mentioned above, in some cases the color check boxes 309 may be initially prefilled with standard colors and the text boxes 312 may be initially prefilled with a default number, such as ‘1’. Since, in the exemplary panel shown in FIGS. 3 and 4, there are nine color check boxes 309, a user may be able to print nine copies of document with a different standard color for the background of each document. The following steps may be used:

1. The user places a document on the scanner/document handler 146 of the multifunction device 101 and selects to copy or scan the document.

2. A preview of the document may be displayed on the screen 303 of the GUI 113.

3. The “Color Picker” option, such as shown in FIG. 3, is displayed on the screen 303. The “Color Picker” has the set of standard colors for the color check boxes 309 and the text boxes 312 prefilled with ‘1’ displayed in the screen 303.

4. Once everything is set, the user clicks on the START button 330, the printer will print nine copies of the document with the standard 9 background colors for single time.

5. If the user wants to change the background colors:
a. The user selects the first color checkbox 309a (tick or cross mark will appear).
b. If the user needs to adjust the color on the adjustable color spectrum 315, the marking point “> <” can be moved so that the color window 306 will change.
c. Alternatively, the user can drag the spot 321 to find the desired color for his document background. The color of the spot 321 will be shown in the display square 324.
d. The user can click on the ‘Add to Colors’ button 327 and the desired color will be displayed in check box 309a.
e. The user can do the same process to fill the other color check boxes (309b, 309c, etc.).

6. If the user wants to change the count for each background color:
a. The user selects the first text box 312a.
b. The user enters the desired value in the text box 312a by pressing the appropriate keys in the numeric keypad 333.
c. Each of the text boxes 312 can be filled with values in the same manner using the numeric keypad 333.

7. Once everything is set, the user clicks on the START button 330, the printer will print the document with desired background colors for the desired count.

8. Clicking on the Clear button 414 will deselect all the selected color check boxes.

In other words, a user can scan a document on a multifunction device. The user then selects a color for the background areas of the document and a number of copies of the document for the selected color. The user can then select another color for the background areas of the document and number of copies of the document for the other color. This may be the same or a different number of copies. Then, with a single push of the START button, the multifunction device will produce numbers of copies of the document in each of the selected colors and quantities.

It is contemplated that when a print job is received, the print job is evaluated to identify job parameter settings associated with the print job. Text or image parameters for the document are identified based on the print job. According to systems and methods herein, the selected color is applied only to the background or other selected portions of the document. Any images or text in the document should remain unchanged. This allows the user to specify one or more background colors at the point of job submission, either through the copier scan interface or printer driver dialog. The number of colors produced by the printer can be limited as desired.

In order to print the selected number of documents in the selected colors, a revised print job is created having the text or image parameters for the document and the selected number of copies of the document for each selected color for the background areas. The revised print job is transmitted to the marking device, which is caused to print the revised print job. In other words, the marking device can automatically print the total number of copies of the document having different colors for the background areas as a result of a single command to print, i.e., a single click on the START button 330.

As shown in FIG. 5, exemplary printers, copiers, multi-function machines, and multi-function devices (MFD) 101 may be located at various different physical locations 506. Other devices according to systems and methods herein may include various computerized devices 508. The computerized devices 508 can include print servers, printing devices, personal computers, etc., and are in communication (operatively connected to one another) by way of a network 502. The network 502 may be any type of network, including a local area network (LAN), a wide area network (WAN), or a global computer network, such as the Internet.

While some exemplary structures are illustrated in the attached drawings, those ordinarily skilled in the art would understand that the drawings are simplified schematic illustrations and that the claims presented below encompass many more features that are not illustrated (or potentially many less) but that are commonly utilized with such devices and systems. Therefore, it is not intended for the claims presented below to be limited by the attached drawings, but instead the attached drawings are merely provided to illustrate a few ways in which the claimed features can be implemented.

The hardware described herein plays a significant part in permitting the foregoing method to be performed, rather than function solely as a mechanism for permitting a solution to be achieved more quickly, (i.e., through the utilization of a computer for performing analysis and calculations). For example, these methods allow a user to print many types of documents in all selected numbers and colors, continuously, without further user intervention. Therefore, such processes as identifying background areas of the document, managing separate colors for separate numbers of the document, and creating a revised print ticket require the use of a computerized image processor to both access the document and to process the document.

As would be understood by one ordinarily skilled in the art, the processes described herein cannot be performed by human alone (or one operating with a pen and a pad of paper) and instead such processes can only be performed by a machine. Specifically, processes such as printing, scanning, changing colors, etc., require the utilization of different specialized machines. Therefore, for example, the production of a revised print ticket based on specific document production instructions associated with identifying background areas, selecting numbers of copies having selected background colors, and scanning/printing the document, which are performed by the devices herein, cannot be performed manually (because machines are required to perform document processing and printing) and such devices are integral with the processes performed by methods herein. Further, such machine-only processes are not mere “post-solution activity” because the automated analysis of each printable document is integral with the steps of the processes described herein. Similarly, the receipt of a print job and conversion of data utilize special-purpose equipment (telecommunications equipment, routers, switches, etc.) that is distinct from a general-purpose processor. In other words, these various machines are integral with the methods herein because the methods cannot be performed without the machines (and cannot be performed by humans alone).

Additionally, the methods herein solve many highly complex technological problems. For example, job pages are automatically revised for selected numbers and selected colors, without further operator intervention. Methods herein solve this technological problem by identifying background areas of the document, receiving input to change the color of the background areas to a selected color for a selected number of copies of the document, and preparing a revised print job ticket having instructions to produce documents with differing background colors corresponding to the selected number for each color. This is especially useful in solving this technological problem because it allows the user to specify one or more background colors at the point of job submission. By granting such benefits, the methods herein reduce the amount and complexity of hardware and software needed to be purchased, installed, and maintained, thereby solving a substantial technological problem that is experienced today.

Aspects of the present disclosure are described herein with reference to flowchart illustrations and/or block diagrams of methods, apparatus (systems), and computer program products according to various systems and methods. It will be understood that each block of the flowchart illustrations and/or two-dimensional block diagrams, and combinations of blocks in the flowchart illustrations and/or block diagrams, can be implemented by computer program instructions. The computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock, Tex., USA and Apple Computer Co., Cupertino, Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well known by those ordinarily skilled in the art and are not described in detail herein to keep this disclosure focused on the salient features presented. The systems and methods herein can encompass devices that print in color, monochrome, or handle color or monochrome image data. All foregoing systems and methods are specifically applicable to electrostatographic and/or xerographic machines and/or processes.

The terminology used herein is for the purpose of describing particular systems and methods only and is not intended to be limiting of this disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

In addition, terms such as “right”, “left”, “vertical”, “horizontal”, “top”, “bottom”, “upper”, “lower”, “under”, “below”, “underlying”, “over”, “overlying”, “parallel”, “perpendicular”, etc., used herein, are understood to be relative locations as they are oriented and illustrated in the drawings (unless otherwise indicated). Terms such as “touching”, “on”, “in direct contact”, “abutting”, “directly adjacent to”, etc., mean that at least one element physically contacts another element (without other elements separating the described elements). Further, the terms “automated” or “automatically” mean that once a process is started (by a machine or a user), one or more machines perform the process without further input from any user.

The corresponding structures, materials, acts, and equivalents of all means or step plus function elements in the claims below are intended to include any structure, material, or act for performing the function in combination with other claimed elements as specifically claimed. The descriptions of the various systems and methods of the present disclosure have been presented for purposes of illustration, but are not intended to be exhaustive or limited to the systems and methods disclosed. Many modifications and variations will be apparent to those of ordinary skill in the art without departing from the scope and spirit of the described systems and methods. The terminology used herein was chosen to best explain the principles of the systems and methods, the practical application or technical improvement over technologies found in the marketplace, or to enable others of ordinary skill in the art to understand the systems and methods disclosed herein.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. Unless specifically defined in a specific claim itself, steps or components of the systems and methods herein cannot be implied or imported from any above example as limitations to any particular order, number, position, size, shape, angle, color, or material.

What is claimed is:

1. A method, comprising:
receiving a print job into a computerized device, said print job comprising a document;
identifying background areas for said document;
receiving input to produce a first number of copies of said document with said background areas having a selected first color;
receiving input to produce a second number of copies of said document with said background areas having a selected second color;
creating a revised print job; and
transmitting said revised print job from said computerized device to a marking device operatively connected to said computerized device.

2. The method according to claim 1, further comprising:
causing said marking device to print said revised print job.

3. The method according to claim 1, said receiving said print job into said computerized device comprising scanning said document.

4. The method according to claim 1, further comprising:
identifying text or image parameters for said document based on said print job.

5. The method according to claim 4, said revised print job further comprising:
said text or image parameters for said document being unchanged.

6. The method according to claim 1, said identifying background areas for said document further comprising displaying a preview of said document.

7. The method according to claim 1, further comprising:
automatically printing said first number of copies of said document and said second number of copies of said document having different colors for said background areas as a result of a single command to print.

8. A method, comprising:
receiving a print job into a computerized device, said print job including print job settings for printing a document;
receiving input, into said computerized device, to produce a first number of copies of said document with a portion of said document having a selected first color;
receiving input, into said computerized device, to produce a second number of copies of said document with said portion of said document having a selected second color, said first color being different from said second color; and
creating a revised print job, using said computerized device, to cause a marking device to automatically print said first number of said document having said portion of said document in said first color and to cause said marking device to automatically print said second number of said document having said portion of said document in said second color.

9. The method according to claim 8, further comprising:
transmitting said revised print job from said computerized device to said marking device, said marking device being operatively connected to said computerized device.

10. The method according to claim 9, further comprising:
causing said marking device to print said revised print job.

11. The method according to claim 8, said receiving said print job into said computerized device comprising scanning said document.

12. The method according to claim 8, further comprising:
displaying a preview of said document, using said computerized device; and
automatically identifying said portion of said document for coloring, using said computerized device.

13. The method according to claim 8, further comprising:
automatically identifying text or image parameters for said document based on said print job, using said computerized device.

14. The method according to claim 13, said revised print job further comprising:
said text or image parameters for said document being unchanged.

15. The method according to claim 8, further comprising:
automatically printing, using said marking device, said document having different colors for said portion of said document as a result of a single command to print.

16. A device, comprising:
a marking device;
a computerized device connected to said marking device, said computerized device receiving a print job comprising a document; and
a graphic user interface operatively connected to said computerized device,
said computerized device identifying background areas for said document, based on said print job, and
said graphic user interface receiving input to produce a first number of copies of said document with said background areas having a selected first color;
said graphic user interface receiving input to produce a second number of copies of said document with said background areas having a selected second color;
said computerized device creating a revised print job, comprising:
said first number of copies of said document having said selected first color for said background areas, and
said second number of copies of said document having said selected second color for said background areas;
said computerized device transmitting said revised print job to said marking device; and
said computerized device causing said marking device to print said revised print job.

17. The device according to claim 16, further comprising:
a scanner, said computerized device receiving said print job further comprising scanning said document.

18. The device according to claim 16, further comprising:
said computerized device automatically identifying text or image parameters for said document.

19. The device according to claim 18, said revised print job further comprising:
said text or image parameters for said document being unchanged.

20. The device according to claim 16, further comprising:
said marking device automatically printing said first number of copies of said document and said second number of copies of said document having different colors for said background areas of said document as a result of a single command to print.
